(19) United States
(12) Patent Application Publication
(10) Pub. No.: US 2012/0313872 A1
(43) Pub. Date: Dec. 13, 2012

(54) ELECTRONIC EQUIPMENT, PRESSURE DETECTING METHOD AND PRESSURE DETECTING DEVICE

(75) Inventors: Wei ZHANG, Hunan (CN); Jian XU, Beijing (CN); Dan LI, Heilongjiang (CN)

(73) Assignee: SONY MOBILE COMMUNICATIONS AB, Lund (SE)

(21) Appl. No.: 13/488,923

(22) Filed: Jun. 5, 2012

(30) Foreign Application Priority Data
Jun. 7, 2011 (CN) 201110150736.3

(51) Int. Cl. G06F 3/041

(52) U.S. Cl. 345/173

(57) ABSTRACT

The present invention provides electronic equipment, pressure detecting method and pressure detecting device. The electronic equipment comprises: a horizontal pressure detecting device arranged at the periphery of the touch screen to detect the pressure applied to the touch screen in the horizontal direction and generate a horizontal pressure signal; and a pressure processing unit to determine the direction of the pressure applied to the touch screen in the horizontal direction according to the horizontal pressure signal generated by the horizontal pressure detecting device. The direction of the pressure applied to the touch screen may be determined by the embodiments of the present invention, and the precision of detection is high, the manufacture is simple, and the cost is low.

### TECHNICAL FIELD

The present invention relates to the field of electronics, and in particular to electronic equipment, pressure detecting method and pressure detecting device.

### BACKGROUND ART

In recent years, touch screens, as information input tools of electronic products, are widely used in various display products, such as a mobile phone, and a computer, etc. A touch screen may be provided on a display screen, and a user may touch the touch screen with a finger or an accessory device, such as a touch pen, so as to input information into the display screen, and reduce, even eliminate dependence on other input devices (such as a keypad, a mouse, etc.).

### SUMMARY OF THE INVENTION

Problems or defects exist in the prior art. For example, the existing touch screens can only detect touch actions, i.e. can only detect whether there exists pressure on the screens, or the touch level; but when it is necessary to detect directions on the touch screens, the directions are calculated based on shift, the direction of an inclined pressure cannot be detected when the inclined pressure is applied to the same point and no shift is generated.

The embodiments of the present invention provide electronic equipment, pressure detecting method and pressure detecting device, with the object being to detect the direction of the pressure applied to a touch screen. According to one aspect of the embodiments of the present invention, there is provided electronic equipment, including a touch screen, and the electronic equipment further including:

a horizontal pressure detecting device arranged at the periphery of the touch screen to detect the pressure applied to the touch screen in the horizontal direction and generate a horizontal pressure signal; and

a pressure processing unit to determine the direction of the pressure applied to the touch screen in the horizontal direction according to the horizontal pressure signal generated by the horizontal pressure detecting device;

wherein the pressure detecting device includes: an isolation layer arranged at the edge of the touch screen, touch points arranged on the isolation layer, and a conductive layer arranged opposite to the isolation layer; the touch points are movable in the horizontal direction, and are in touch with the conductive layer to generate the horizontal pressure signal.

According to another aspect of the embodiments of the present invention, the touch points are multiple, and the distances from at least two touch points to the conductive layer are different.

According to a further aspect of the embodiments of the present invention, the processing unit includes:

a position determining unit to determine the positions of the touch points in touch with the conductive layer according to the horizontal pressure signal; and

a direction determining unit to determine the direction of the pressure applied to the touch screen in the horizontal direction according to the positions of the touch points in touch with the conductive layer.

According to a further still aspect of the embodiments of the present invention, the processing unit further includes:

a number determining unit to determine the number of the touch points in touch with the conductive layer according to the horizontal pressure signal; and

a level determining unit to determine the level of the pressure applied to the touch screen in the horizontal direction according to the number of the touch points in touch with the conductive layer.

According to a further still aspect of the embodiments of the present invention, the distances from the touch points to the conductive layer are between 0.01 millimeter and 0.1 millimeter.

According to a further still aspect of the embodiments of the present invention, the horizontal pressure detecting device further includes: point gaskets arranged on the isolation layer and in touch with the conductive layer to space apart and support the isolation layer and the conductive layer.

According to a further still aspect of the embodiments of the present invention, the point gaskets are arranged spaced apart from the touch points.

According to a further still aspect of the embodiments of the present invention, the electronic equipment further includes:

a vertical pressure detecting device arranged below the touch screen to detect the pressure applied to the touch screen in the vertical direction and generate a vertical pressure signal;

and the pressure processing unit is further used to determine the level and direction of the pressure applied to the touch screen according to the horizontal pressure signal generated by the horizontal pressure detecting device and the vertical pressure signal generated by the vertical pressure detecting device.

According to a further still aspect of the embodiments of the present invention, there is provided a pressure detecting method, applicable to a touch screen, the pressure detecting method including:

a horizontal pressure detecting step: generating a horizontal pressure signal by touch points moving in the horizontal direction and in touch with a conductive layer, the touch point being arranged on an isolation layer at the periphery of the touch screen; and

a pressure determining step: determining the direction of the pressure applied to the touch screen in the horizontal direction according to the horizontal pressure signal.

According to a further still aspect of the embodiments of the present invention, the touch points are multiple, and the distances from at least two touch points to the conductive layer are different.

According to a further still aspect of the embodiments of the present invention, the pressure determining step specifically includes:

a position determining step: determining the positions of the touch points in touch with the conductive layer according to the horizontal pressure signal; and

a direction determining step: determining the direction of the pressure applied to the touch screen in the horizontal direction according to the positions of the touch points in touch with the conductive layer.

According to a further still aspect of the embodiments of the present invention, the method further includes:

a number determining step: determining the number of the touch points in touch with the conductive layer according to the horizontal pressure signal; and

a level determining step: determining the level of the pressure applied to the touch screen in the horizontal direction according to the number of the touch points in touch with the conductive layer.

According to a further still aspect of the embodiments of the present invention, the method further includes:

a vertical pressure detecting step: detecting the pressure applied to the touch screen in the vertical direction and generating a vertical pressure signal;

and the pressure determining step further includes: determining the level and direction of the pressure applied to the touch screen according to the horizontal pressure signal and the vertical pressure signal.

According to a further still aspect of the embodiments of the present invention, there is provided a pressure detecting device arranged at the periphery of a touch screen, the pressure detecting device including:

an isolation layer arranged at the edge of the touch screen;

touch points arranged on the isolation layer and movable in the horizontal direction; and

a conductive layer arranged opposite to the isolation layer, which generates an electrical signal when in touch with the touch points.

According to a further still aspect of the embodiments of the present invention, the touch points are multiple, and the distances from at least two touch points to the conductive layer are different.

According to a further still aspect of the embodiments of the present invention, the distances from the touch points to the conductive layer are between 0.01 millimeter and 0.1 millimeter.

According to a further still aspect of the embodiments of the present invention, the pressure detecting device further includes:

point gaskets arranged on the isolation layer and in touch with the conductive layer to space apart and support the isolation layer and the conductive layer.

According to a further still aspect of the embodiments of the present invention, the point gaskets are arranged spaced apart from the touch points.

The advantages of the embodiments of the present invention are that the direction of the pressure applied to the touch screen may be determined by detecting the pressure applied to the touch screen in the horizontal direction by a resistive pressure detecting device, and the precision of detection is high, the manufacture is simple, and the cost is low.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments. It should be emphasized that the term “includes/including” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a schematic diagram showing the structure of the electronic equipment of the embodiments of the present invention;

FIG. 2 is a schematic diagram showing the decomposition of the pressure of the embodiments of the present invention;

FIG. 3 is an exemplary view of the electronic equipment of the embodiments of the present invention;

FIG. 4 is an exemplary fragmentary view showing the structure of the pressure detecting device of the embodiments of the present invention without applied pressure;

FIG. 5 is an exemplary fragmentary view showing the structure of the pressure detecting device of the embodiments of the present invention being applied pressure;

FIG. 6 is an exemplary view showing the pressure detecting device of the embodiments of the present invention arranged at the periphery of a touch screen;

FIG. 7 is a schematic diagram showing the composition of the pressure of the embodiments of the present invention;

FIG. 8 is a schematic diagram showing a flowchart of the pressure detecting method of the embodiments of the present invention;

FIG. 9 is a schematic diagram showing another flowchart of the pressure detecting method of the embodiments of the present invention;

FIG. 10 is a schematic block diagram of the systematic structure of the electronic equipment of the embodiments of the present invention.

### DETAILED DESCRIPTION OF THE INVENTION

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the invention are described primarily in the context of a portable electronic device in the form of a mobile telephone (also referred to as “mobile phone”). However, it shall be appreciated that the invention is not limited to the context of a mobile telephone and may relate to any type of appropriate electronic apparatus having the function of photographing and sound recording.

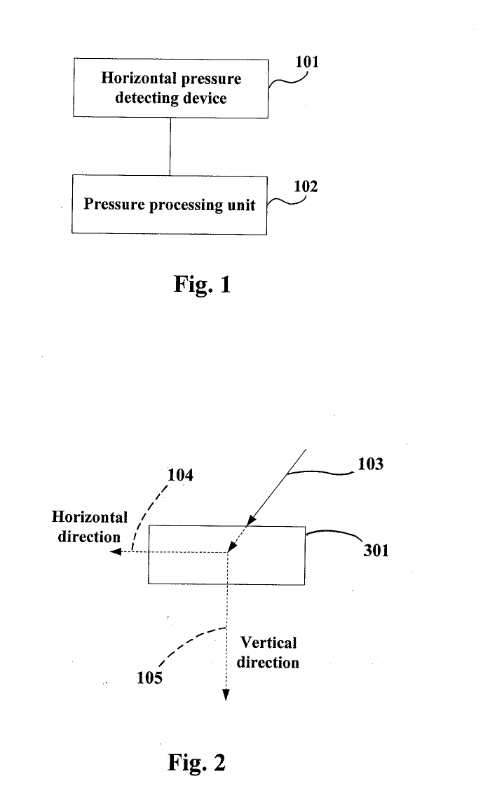

The embodiments of the present invention provide electronic equipment, including a touch screen (shown at 301 in several drawing figures). FIG. 1 is a schematic diagram showing the structure of the electronic equipment of the embodiments of the present invention. As shown in FIG. 1, the electronic equipment further includes a horizontal pressure detecting device 101 and a pressure processing unit 102. The horizontal pressure detecting device 101 is arranged at the periphery of the touch screen 301 and is used to detect the pressure applied to the touch screen in the horizontal direction, e.g., as is illustrated schematically in FIG. 2, generally in parallel with the generally planar extent of the touch screen, and to generate a horizontal pressure signal when it is detected that a pressure is applied to the touch screen in the horizontal direction. The pressure processing unit 102 is used to determine the direction of the pressure applied to the touch screen 301 in the horizontal direction according to the horizontal pressure signal generated by the horizontal pressure detecting device 101.

In this embodiment, according to the principles of force decomposition and composition, when an inclined pressure is applied to the touch screen 301, pressures may be generated both in the horizontal direction and the vertical direction.

FIG. 2 is a schematic diagram showing the decomposition of the pressure of the embodiments of the present invention. As shown in FIG. 2, after an inclined pressure, which is represented by arrow 103, is applied to the touch screen 301, a pressure 104 may be generated in the horizontal direction. Such a pressure in the horizontal direction may be detected by a horizontal pressure detecting device 101 arranged at the periphery of the touch screen, so as to determine the direction of the pressure applied to the touch screen.

In this embodiment, the touch screen 301 may be a capacitive touch screen, and the horizontal pressure detecting device 101 may be a part of a resistive screen, and may be a resistive pressure detecting device. In particular implementation, the horizontal pressure detecting device 101 may be arranged at the peripheral of the touch screen 301, including the upper, the lower, the left, and the right.

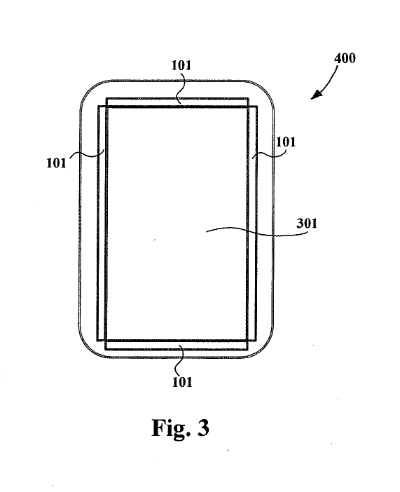

FIG. 3 is an exemplary view of the electronic equipment 400 of the embodiments of the present invention. As shown in FIG. 3, the horizontal pressure detecting device 101 is arranged at the periphery of the touch screen 301, and the pressure processing unit 102, which is not shown in this figure, may be integrated into the electronic equipment 400.

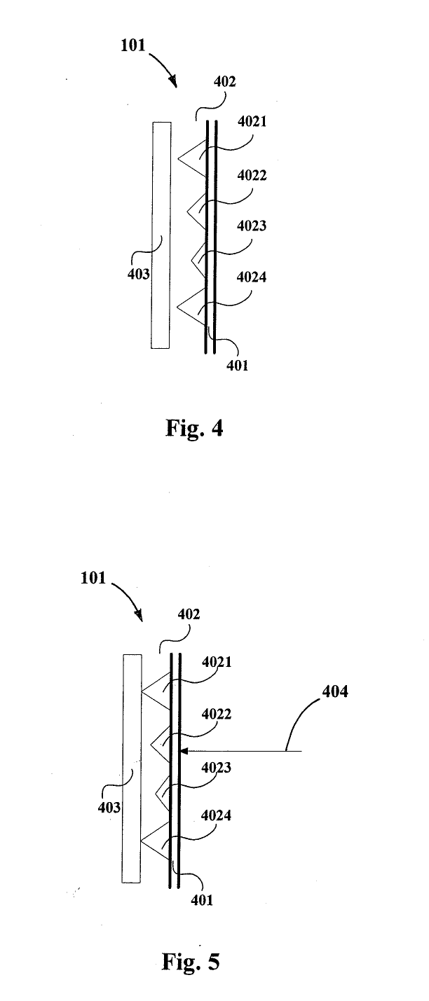

In this embodiment, the horizontal pressure detecting device 101 may detect the pressure through the touch of touch points with a conductive layer, thereby further improving the precision of detection. FIG. 4 is an exemplary fragmentary view showing the structure of the pressure detecting device 101 of the embodiments of the present invention without applied pressure As shown in FIG. 4, the horizontal pressure detecting device 101 includes:

an isolation layer 401 arranged at the edge of the touch screen 301;

touch points 402 arranged on the isolation layer 401; and

a conductive layer 403 arranged opposite to the isolation layer 401; the conductive layer 403 is not in touch with (not touching) the touch points 402 when no pressure is applied.

Furthermore, the touch points 402 may be multiple, and the distances from at least two touch points to the conductive layer are different, i.e. the distances from each of the touch points to the conductive layer are not completely identical. For example, as shown in FIG. 4, the distances of the touch point 4021 and the touch point 4024 to the conductive layer 403 may be 0.03 millimeter, the distance of the touch point 4022 to the conductive layer 403 may be 0.06 millimeter, and the distance of the touch point 4023 to the conductive layer 403 may be 0.09 millimeter.

When no pressure is applied to the isolation layer 401, the distance from the touch points 402 to the conductive layer 403 may be between 0.01 millimeter and 0.1 millimeter. What is described above is only exemplary description of the touch points, however, it is not limited thereto, and particular implementation may be determined as actually required.

In this embodiment, the isolation layer 401 may be of an elastic material, which is deformable when it is applied a slight pressure from the touch screen 301. The touch points 402 may be provided with ITO (indium tin oxide), forming a circuit when it is in touch with the conductive layer 403, thereby generating an electrical signal. The electrical signal may be generated in a manner of the prior art, which shall not be described any further.

FIG. 5 is an exemplary fragmentary view showing the structure of the pressure detecting device 101 of the embodiments of the present invention being applied pressure. As shown in FIG. 5, when a represented by arrow 404 pressure is applied to the isolation layer 401, the touch points 402 are pushed to move in the horizontal direction, and hence the touch point 4021 and the touch point 4024 are in touch with the conductive layer 403, and the conductive layer 403 generates an electrical signal when it is in touch with the touch point 4021 and the touch point 4024.

FIG. 6 is an exemplary view showing the pressure detecting device 101 of the embodiments of the present invention arranged at the periphery of a touch screen 301. As shown in FIG. 6, the pressure detecting device may further include point gaskets (spacers) 601 arranged on the isolation layer 401 and in touch with the conductive layer 403 to space apart and support the isolation layer 401 and the conductive layer 403. Thus, changes in the natural touch of the touch points 402 and the conductive layer 403 due to the aging of the resistive screen may be prevented, and the lifetime of the resistive screen may be prolonged.

Furthermore, the point gaskets 601 may be arranged spaced apart from the touch points 402, so as to improve the detection precision of the resistive screen. For example, five touch points 4021-4025 may be arranged between each two point gaskets 601. What is described above is exemplary only, and particular implementation may be determined as actually required.

Thus, the direction of the pressure applied to the touch screen in the horizontal direction may be determined by detecting the pressure applied to the touch screen in the horizontal direction by a resistive pressure detecting device 101, and the precision of detection is high, the manufacture is simple, and the cost is low.

In an embodiment, the processing unit 102 may include a position determining unit and a direction determining unit (not shown). The position determining unit determines the positions of the touch points 402 in touch with the conductive layer 403 according to the horizontal pressure signal output by the horizontal pressure detecting device 101; and the direction determining unit determines the direction of the pressure applied to the touch screen 301 in the horizontal direction according to the positions of the touch points 402 in touch with the conductive layer 401.

For example, as shown in FIG. 6, the position determining unit may first determine the touch points 402 in touch with the conductive layer according to the horizontal pressure signal output from the horizontal pressure detecting device 101. If it is determined that the touch points 402 in touch with the conductive layer are 4021 and 4024, and the touch points 4021 and 4024 are arranged at the left to the touch screen, the position determining unit may determine that the positions of the touch points in touch with the conductive layer are “left”. Thus, the direction determining unit may determine that the direction of the pressure applied to the touch screen in the horizontal direction is “left”.

In an embodiment, the processing unit 102 may further include a number determining unit and a level determining unit (not shown in this figure). The number determining unit determines the number of the touch points in touch with the conductive layer according to the electrical signal output by the horizontal pressure detecting device 101; and the level determining unit determines the level of the pressure applied to the touch screen according to the number of the touch points in touch with the conductive layer.

For example, as shown in FIG. 6, the number determining unit may first determine the touch points in touch with the conductive layer according to the electrical signal output from the horizontal pressure detecting device. If it is determined that the touch points in touch with the conductive layer are 4021, 4022, 4024 and 4025, the number determining unit may determine that the number of the touch points in touch with the conductive layer is “4”. Thus, the level determining unit may determine that the level of the pressure applied to the touch screen in the horizontal direction is “8”.

If it is determined that the touch points in touch with the conductive layer are 4021 and 4024, the number determining unit may determine that the number of the touch points in touch with the conductive layer is “2”. Thus, the level determining unit may determine that the level of the pressure applied to the touch screen in the horizontal direction is “4”.

In another embodiment, the electronic equipment further includes a vertical pressure detecting device (not shown) arranged below the touch screen to detect the pressure applied to the touch screen in the vertical direction and generate a vertical pressure signal.

In particular, an existing pressure sensor may be used as the vertical pressure detecting device, or the structure shown in FIG. 4 may be used. Particular implementation may be determined as actually required.

The pressure processing unit 102 is further used to determine the level and direction of the pressure applied to the touch screen according to the horizontal pressure signal generated by the horizontal pressure detecting device 101 and the vertical pressure signal generated by the vertical pressure detecting device.

In particular, the level of the pressure applied in the horizontal direction (104, for example, as shown in FIG. 2) may be determined according to the horizontal pressure signal, the level of the pressure applied in the vertical direction (105, for example, as shown in FIG. 2) may be determined according to the vertical pressure signal, and then the composition of pressure may be performed according to the parallelogram rule.

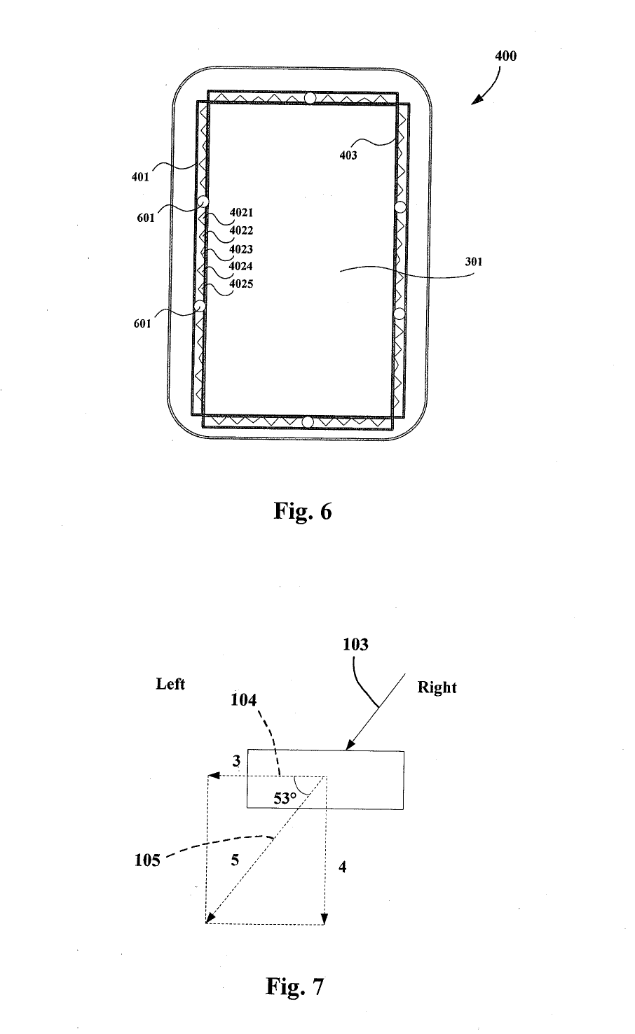

For example, FIG. 7 is a schematic diagram showing the composition of the pressure 103 of the embodiments of the present invention. As shown in FIG. 7, if the level of the pressure in the horizontal direction 104 is “3”, and the direction is “left”, the level of the pressure in the vertical direction 105 is “4”, and the direction is “lower”, it can be determined that the level of the pressure 103 applied to the touch screen is “5”, and the direction is “left lower 53°”.

In specific implementation, an application programming interface may be provided to realize above function. For example, the following interface function may be provided:

Pressure.getRoughDirection( ).

The information on the direction of the pressure applied to the touch screen in the horizontal direction (such as “left”) may be returned via the interface function, indicative of that the direction of the pressure applied in the horizontal direction is “left”.

Or, the following interface function may also be provided:

Pressure.getPreciseDirection( ).

The information on the direction and level of the pressure applied to the touch screen may be returned via the interface function. For example, returning (left, 8) indicates that the direction of the pressure applied in the horizontal direction is “left”, and the level of the pressure applied in the horizontal direction is “8”; and returning (left, 53°, 8) indicates that the direction of the pressure applied is “left lower 53°”, and the level of the pressure applied is “8”. In this way, the result of detection will be more precise, and the application of the electronic equipment may perform application process according to such information.

What is described above is only exemplary description of the detection of pressure, however, it is not limited thereto, and particular implementation may be determined as actually required.

It can be seen from the above embodiments that the direction of the pressure applied to the touch screen may be determined by detecting the pressure applied to the touch screen in the horizontal direction by a resistive pressure detecting device, and the precision of detection is high, the manufacture is simple, and the cost is low.

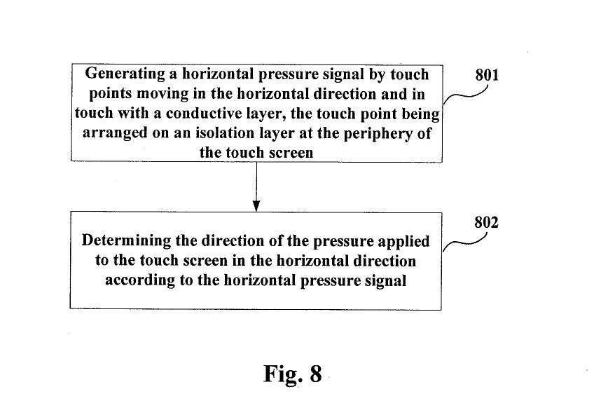

The embodiments of the present invention further provide a pressure detecting method, applicable to a touch screen. FIG. 8 is a schematic diagram showing a flowchart of the pressure detecting method of the embodiments of the present invention. As shown in FIG. 8, the pressure detecting method includes the following steps:

Step 801: generating a horizontal pressure signal by touch points moving in the horizontal direction and in touch with a conductive layer, the touch points being arranged on an isolation layer at the periphery of the touch screen; and

Step 802: determining the direction of the pressure applied to the touch screen in the horizontal direction according to the horizontal pressure signal.

In particular, a user may click or press the touch screen. In a case where the angle of a press is not vertical, a pressure is applied to the touch screen in the horizontal direction, and the isolation layer is pushed to slightly shift, causing the touch points to move slightly in the horizontal direction, thus making the touch points to be in touch with the conductive layer to generate a horizontal pressure signal.

Furthermore, in one embodiment, the touch points may be multiple, and the distances from at least two touch points to the conductive layer are different.

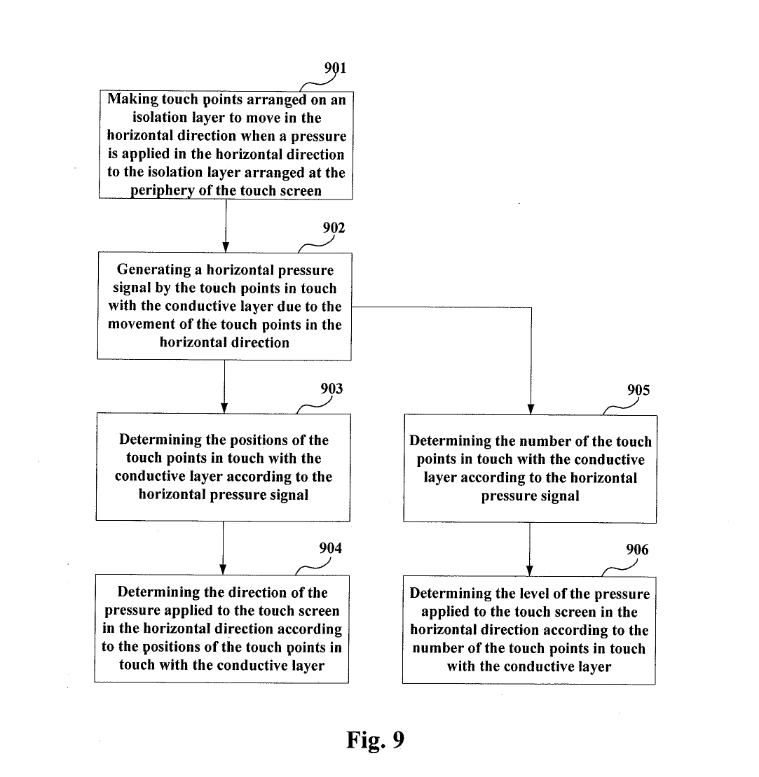

FIG. 9 is a schematic diagram showing another flowchart of the pressure detecting method of the embodiments of the present invention. As shown in FIG. 9, the pressure detecting method includes:

Step 901: making touch points arranged on an isolation layer to move in the horizontal direction when a pressure is applied in the horizontal direction to the isolation layer arranged at the periphery of the touch screen;

Step 902: generating a horizontal pressure signal by the touch points in touch with the conductive layer due to the movement of the touch points in the horizontal direction;

Step 903: determining the positions of the touch points in touch with the conductive layer according to the horizontal pressure signal; and

Step 904: determining the direction of the pressure applied to the touch screen in the horizontal direction according to the positions of the touch points in touch with the conductive layer.

As shown in FIG. 9, the method may further include:

Step 905: determining the number of the touch points in touch with the conductive layer according to the horizontal pressure signal; and

Step 906: determining the level of the pressure applied to the touch screen in the horizontal direction according to the number of the touch points in touch with the conductive layer.

In one embodiment, the pressure detecting method may further include:

detecting the pressure applied to the touch screen in the vertical direction and generating a vertical pressure signal; and

determining the level and direction of the pressure applied to the touch screen according to the horizontal pressure signal and the vertical pressure signal.

It can be seen from the above embodiments that the direction of the pressure applied to the touch screen may be determined by detecting the pressure applied to the touch screen in the horizontal direction by a resistive pressure detecting device, and the precision of detection is high, the manufacture is simple, and the cost is low.

The embodiments of the present invention further provide a pressure detecting device arranged at the periphery of a touch screen. The pressure detecting device includes:

an isolation layer 401 arranged at the edge of the touch screen;

touch points 402 arranged on the isolation layer and movable in the horizontal direction; and

a conductive layer 403 arranged opposite to the isolation layer, which generates an electrical signal when in touch with the touch points.

Furthermore, the touch points 402 may be multiple, and the distances from at least two touch points to the conductive layer 403 may be different. Preferably, the distances from the touch points to the conductive layer are between 0.01 millimeter and 0.1 millimeter when no pressure is applied to the isolation layer.

Furthermore, the pressure detecting device further includes: Point gaskets 601 arranged on the isolation layer 401 and in touch with the conductive layer 403 to space apart and support the isolation layer and the conductive layer. The point gaskets may be arranged spaced apart from the touch points.

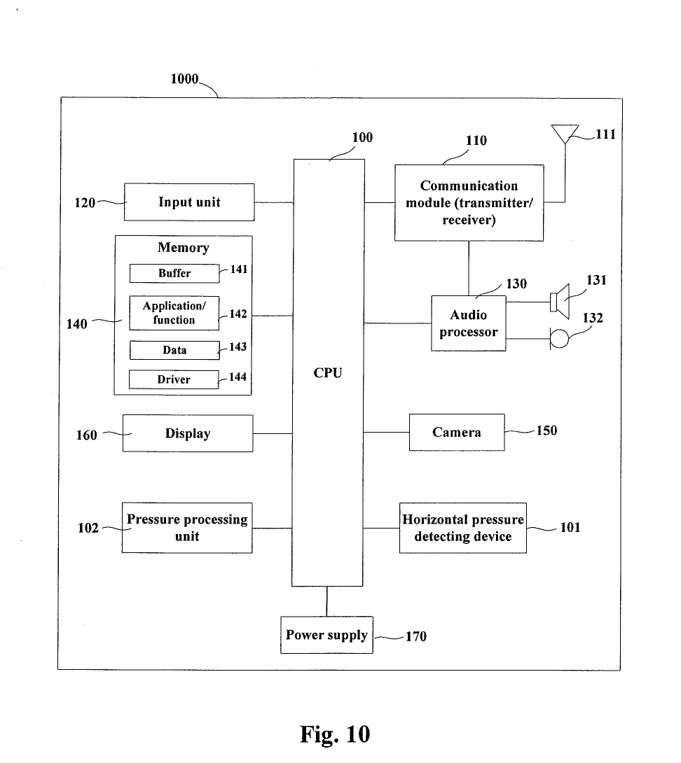

FIG. 10 is a schematic block diagram of the systematic structure of the electronic equipment 1000 (also designated by reference numeral 400 in FIGS. 3 and 6) of the embodiments of the present invention, wherein the above-described touch screen 301 (not shown), the horizontal pressure detecting device 101 and the pressure processing unit 102 are included. Such a figure is exemplary only, and other types of structures may be used to supplement or replace this structure for the realization of telecommunications functions or other functions.

As shown in FIG. 10, the electronic equipment 1000 may further include a central processing unit 100, a communication module 110, an input unit 120, an audio processor 130, a memory 140, a camera 150, a display 160, and a power supply 170.

The horizontal pressure detecting device 101 and the pressure processing unit 102 may be connected directly, and may be connected via the central processing unit 100. The pressure processing unit 102 may also be integrated into the central processing unit 100.

The central processing unit 100 (sometimes referred to as a controller or operating control, which may include a microprocessor or other processor devices and/or logic devices), receives input and controls components and operations of the electronic equipment 1000. The input unit 120 provides input to the central processing unit 100. The input unit 120 is, for example, a key or a touch input device. The camera 150 is used to take image data and provide the taken image data to the central processing unit 100, for use in a conventional manner, such as storage, and transmission, etc.

The power supply 170 is used to supply electric power to the electronic equipment 1000. The display 160 is used to display the display objects, such as images and characters, etc. The display may be, for example, an LED display, but it is not limited thereto.

The memory 140 is coupled to the central processing unit 100. The memory 140 may be a solid-state memory, such as a read-only memory (ROM), a random access memory (RAM), and a SIM card, etc. It may also be such a memory that stores information when the power is interrupted, may be optionally erased and provided with more data. Examples of such a memory are sometimes referred to as an EPROM, etc. The memory 140 may also be certain other types of devices. The memory 140 includes a buffer memory 141 (sometimes referred to as a buffer). The memory 140 may include an application/function storing portion 142 used to store application programs and function programs, or to execute the flow of the operation of the electronic equipment 1000 via the central processing unit 100.

The memory 140 may further include a data storing portion 143 used to store data, such as a contact person, digital data, pictures, voices and/or any other data used by other electronic devices. A driver storing portion 144 of the memory 140 may include various types of drivers of electronic devices for the communication function and/or for executing other functions (such as application of message transmission, and application of directory, etc.) of the electronic devices.

The communication module 110 is a transmitter/receiver transmitting and receiving signals via an antenna 111. The communication module (transmitter/receiver) 110 is coupled to the central processing unit 100 to provide input signals and receive output signals, this being similar to the case in a conventional mobile phone.

A plurality of communication modules 110 may be provided in the same electronic device for various communication technologies, such a cellular network module, a Bluetooth module, and/or wireless local network module, etc. The communication module (transmitter/receiver) 110 is also coupled to a loudspeaker 131 and a microphone 132 via the audio processor 130, for providing audio output via the loudspeaker 131 and receiving the audio input from the microphone 132, thereby achieving common telecommunications functions. The audio processor 130 may include any appropriate buffers, decoders, and amplifiers, etc. The audio processor 130 is further coupled to the central processing unit 100, thereby enabling the recording of voices in this device via the microphone 132 and playing the voices stored in this device via the loudspeaker 131.

It can be seen from the above embodiments that the direction of the pressure applied to the touch screen may be determined by detecting the pressure applied to the touch screen in the horizontal direction. And the direction and level of the pressure applied to the touch screen may be precisely detected by composing the pressures applied to the touch screen in the horizontal direction and the vertical direction.

The preferred embodiments of the present invention are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact structure and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. Electronic equipment, comprising a touch screen, and the electronic equipment further comprising:
a horizontal pressure detecting device arranged at the periphery of the touch screen configured to detect pressure applied to the touch screen in the relatively horizontal direction and generate a horizontal pressure signal; and
a pressure processing unit configured to determine the direction of the pressure applied to the touch screen in the horizontal direction according to the horizontal pressure signal generated by the horizontal pressure detecting device;
wherein the pressure detecting device comprises: an isolation layer arranged at the edge of the touch screen, touch points arranged on the isolation layer, and a conductive layer arranged opposite to the isolation layer; wherein the touch points are movable in the horizontal direction, and are configured such that when in touch with the conductive layer a horizontal pressure signal is generated.

2. The electronic equipment according to claim 1, wherein the touch points are multiple, and the distances from at least two touch points to the conductive layer absent pressure applied to the touch screen in the horizontal direction are different.

3. The electronic equipment according to claim 2, wherein the pressure processing unit comprises:
a position determining unit configured to determine the positions of the touch points in touch with the conductive layer according to the horizontal pressure signal; and
a direction determining unit configured to determine the direction of the pressure applied to the touch screen in the horizontal direction according to the positions of the touch points in touch with the conductive layer.

4. The electronic equipment according to claim 3, wherein the pressure processing unit further comprises:
a number determining unit to determine the number of the touch points in touch with the conductive layer according to the horizontal pressure signal; and
a level determining unit configured to determine the level of the pressure applied to the touch screen in the horizontal direction according to the number of the touch points in touch with the conductive layer.

5. The electronic equipment according to claim 2, wherein the distances from the touch points to the conductive layer are between 0.01 millimeter and 0.1 millimeter.

6. The electronic equipment according to claim 2, wherein the horizontal pressure detecting device further comprises:
point gaskets arranged on the isolation layer and in touch with the conductive layer spacing apart and supporting the isolation layer and the conductive layer.

7. The electronic equipment according to claim 6, wherein the point gaskets are arranged spaced apart from the touch points.

8. The electronic equipment according to claim 1, wherein the electronic equipment further comprises:
a vertical pressure detecting device arranged below the touch screen to detect the pressure applied to the touch screen in the vertical direction and generate a vertical pressure signal; and
the pressure processing unit is further configured to determine the level and direction of the pressure applied to the touch screen according to the horizontal pressure signal generated by the horizontal pressure detecting device and the vertical pressure signal generated by the vertical pressure detecting device.

9. A pressure detecting method, applicable to a touch screen, the pressure detecting method comprising:
a horizontal pressure detecting step: generating a horizontal pressure signal by touch points moving in the horizontal direction and in touch with a conductive layer, the touch point being arranged on an isolation layer at the periphery of the touch screen; and
a pressure determining step: determining the direction of the pressure applied to the touch screen in the horizontal direction according to the horizontal pressure signal.

10. The pressure detecting method according to claim 9, wherein the touch points are multiple, and the distances from at least two touch points to the conductive layer are different.

11. The pressure detecting method according to claim 10, wherein the pressure determining step specifically comprises:
a position determining step: determining the positions of the touch points in touch with the conductive layer according to the horizontal pressure signal; and
a direction determining step: determining the direction of the pressure applied to the touch screen in the horizontal direction according to the positions of the touch points in touch with the conductive layer.

12. The pressure detecting method according to claim 11, wherein the method further comprises:
a number determining step: determining the number of the touch points in touch with the conductive layer according to the horizontal pressure signal; and
a level determining step: determining the level of the pressure applied to the touch screen in the horizontal direction according to the number of the touch points in touch with the conductive layer.

13. The pressure detecting method according to claim 9, wherein the method further comprises:
a vertical pressure detecting step: detecting the pressure applied to the touch screen in the vertical direction and generating a vertical pressure signal;
and the pressure determining step further comprises: determining the level and direction of the pressure applied to the touch screen according to the horizontal pressure signal and the vertical pressure signal.

14. A pressure detecting device arranged at the periphery of a touch screen, the pressure detecting device comprising:
an isolation layer arranged at the edge of the touch screen;
touch points arranged on the isolation layer and movable in the horizontal direction; and
a conductive layer arranged opposite to the isolation layer, which generates an electrical signal when in touch with the touch points.

15. The pressure detecting device according to claim 14, wherein the touch points are multiple, and the distances from at least two touch points to the conductive layer are different.

16. The pressure detecting device according to claim 15, wherein the distances from the touch points to the conductive layer are between 0.01 millimeter and 0.1 millimeter.

17. The pressure detecting device according to claim 15, wherein the pressure detecting device further comprises:
point gaskets arranged on the isolation layer and in touch with the conductive layer to space apart and support the isolation layer and the conductive layer.

18. The pressure detecting device according to claim 17, wherein the point gaskets are arranged spaced apart from the touch points.
